(19) United States
(12) Patent Application Publication
(10) Pub. No.: US 2026/0132224 A1
(43) Pub. Date: May 14, 2026

(54) METHOD FOR PRODUCING SILYLATED CELLULOSE

(71) Applicants: Dow Global Technologies LLC, Midland, MI (US); Dow Silicones Corporation, Midland, MI (US)

(72) Inventors: Beata Kilos, Midland, MI (US); Marc-Andre Courtemanche, Midland, MI (US); Matthew McLaughlin, Midland, MI (US); Michael Telgenhoff, Midland, MI (US); David Williams, Midland, MI (US); Ryan Baumgartner, Midland, MI (US)

(21) Appl. No.: 19/118,381

(22) PCT Filed: Nov. 21, 2023
(86) PCT No.: PCT/US2023/080624

§ 371 Date: Apr. 4, 2025

Related U.S. Application Data
(60) Provisional application No. 63/432,713, filed on Dec. 15, 2022.

(51) Int. Cl. C08B 15/05

(52) U.S. Cl. CPC C08B 15/05

(57) ABSTRACT

A method for preparing silylated cellulose is disclosed. The method includes preparing a reaction product in the form of a paste and removing unreacted starting materials and/or by-products from the paste to form a powdered silylated cellulose.

### CROSS REFERENCE TO RELATED APPLICATIONS

This application claims the benefit of U.S. Provisional Patent Application Ser. No. 63/432,713 filed on 15 Dec. 2022 under 35 U.S.C. § 119(e). U.S. Provisional Patent Application Ser. No. 63/432,713 is hereby incorporated by reference.

### FIELD

A method for producing a silylated cellulose is provided. More particularly, the method for producing the silylated cellulose can be utilized on a commercial production scale.

### INTRODUCTION

Current technologies for producing silylated cellulose are based on low volume yield slurry or solution processes. Some of these processes utilize high pressure, where the cellulose is in a slurry of liquified ammonia. Others utilize atmospheric pressure processes in high volumes of swelling solvents. These processes suffer from the drawbacks of requiring very large volumes of swelling solvents and recrystallization solvents and producing large volumes of resulting waste. Additionally, the space time yield of these processes are very low due to the volume requirements of the solvents. Therefore, these processes have not been commercially viable for larger scale usage.

U.S. Pat. No. 4,320,692 to Green discloses a method for the preparation of trimethylsilyl cellulose ethers, which comprises reacting cellulose with hexamethyldisilazane in the presence of a small quantity of catalyst. In the preferred method of carrying out the process, the reaction temperature is maintained between about 100° C. and about 135° C. At temperatures below 100° C. the reactions were found to be so slow that they were impractical and at temperatures above 135° C. the reactions were found to be very erratic.

There is an industry need for a more volume efficient process to prepare silylated cellulose. It would be desirable also for the process to operate at ambient pressures and/or utilize less solvent than existing processes.

### SUMMARY

A method for preparing a silylated cellulose is provided herein. The method comprises:
1) combining starting materials comprising
   A) a cellulose,
   B) a polar aprotic swelling agent,
   C) a catalyst, and
   D) a silylating agent comprising a silyl amine,
thereby forming a reaction mixture; and
2) mixing the reaction mixture in a reactor with self-wiping mixing blades and heating the reaction mixture, thereby forming a reaction product comprising the silylated cellulose. The starting materials used in the method comprise starting materials A), B), C), and D) introduced above, and the starting materials are used in amounts sufficient to prepare the reaction product as a paste.

### DETAILED DESCRIPTION

More particularly, the method for preparing the silylated cellulose introduced above comprises:
1) combining starting materials comprising
   A) the cellulose, which comprises repeating monomeric units having >2.5 hydroxyl groups per monomeric unit,
   B) the polar aprotic swelling agent,
   C) the catalyst,
   D) the silylating agent comprising the silyl amine, which has a silicon-nitrogen (Si—N) moiety, and
   optionally E) a solvent,
thereby forming the reaction mixture; and
2) mixing the reaction mixture in a reactor with self-wiping mixing blades and heating the reaction mixture at a temperature of 30° C. to 150° C., thereby forming a reaction product comprising the silylated cellulose. The starting materials comprising A), B), C), and D) are used in amounts sufficient to prepare the reaction product as a paste.

The method may optionally further comprise one or more additional steps. For example, the method may further comprise drying A) the cellulose before step 1). Commercially available cellulose may comprise adsorbed water. To minimize by-product formation, the cellulose may be dried to remove at least some of the water. Drying may be performed by any convenient means, such as exposing the cellulose to heat and/or reduced pressure or a flow of inert gas.

The method may optionally further comprise adding E) a solvent that differs from B) the polar aprotic swelling agent, for example, in step 1) or step 2). Alternatively, the method may further comprise an additional step comprising: dissolving C) the catalyst in one or both of B) the polar aprotic swelling agent and E) the solvent, before step 1) to form a catalyst solution. The resulting catalyst solution may be mixed with A) the cellulose before step 1) (e.g., before adding D) the silylating agent into the reactor). For example, the catalyst solution may be mixed with A) the cellulose for at least 10 minutes, alternatively at least 15 minutes; while at the same time the catalyst solution may be mixed with A) the cellulose for up to 1 hour, before adding D) the silylating agent.

Alternatively, the method may further comprise an additional step comprising: forming C) the catalyst by a method comprising reacting a portion of D) the silylating agent with an acid ex-situ. Optionally E) a solvent may be used to facilitate combining D) the silylating agent and the acid. When this step is added to the method, the silylating agent used for forming the catalyst may be, but is not limited to, a silazane as described below for starting material D). The silazane selected for forming the catalyst may be the same as, or different from, starting material D) used in step 1) to perform the silylation reaction. This step may be performed via any convenient means such as mixing, e.g., at RT and ambient pressure.

In step 2), the reaction mixture is mixed for 15 min to ≥24 hours, alternatively 15 min to 24 h, alternatively 30 min to 2 h. The temperature in step 2) may be 30° C. to 150° C., alternatively 50° C. to 85° C., alternatively 50° C. to 80° C., and alternatively 55° C. to 80° C. The pressure in step 2) may be 730 mmHg (97 kPa) to 790 mmHg (105 kPa), alternatively 750 mmHg (100 kPa) to 770 mmHg (103 kPa). The reaction mixture and/or the reaction product produced in step 2) has a consistency of a paste that cannot be mixed in a standard reaction vessel with a single mixing blade, nor can the reaction mixture be readily pumped. If cooled to RT, the paste may form a solid. If the paste were to form in a reactor with a single mixing blade, at RT the paste would solidify on the mixing blade and would need to be manually removed from the reactor (i.e., the intractable solid that would form is incapable of being comminuted in the reactor and could not be pumped from the reactor, as exemplified below in Comparative Example 5). Therefore, a reactor capable of mixing a reaction mixture and reaction product with this consistency is used. The reactor has self-wiping mixing blades and may be, for example, a kneader reactor or a sigma blade reactor. Without wishing to be bound by theory, it is thought that the self-wiping mixing blades are capable of preventing an intractable solid from forming by continuously tearing fibrous, crystalline, and/or entangled components and maintaining mixing in the reactor.

The method may further comprise step 3): heating the reaction product at a temperature of >50° C. to 105° C. at a pressure of >0 kPa to <101 kPa, thereby forming a friable solid or powder comprising the silylated cellulose. Alternatively, the temperature in step 3) may be 60° C. to 105° C., alternatively 65° C. to 90° C. Without wishing to be bound by theory, it is thought that step 3) will remove most residual ammonia and residual D) silylating agent, thereby converting the reaction product to a friable solid that can easily be comminuted to form a powdered silylated cellulose, which can be mixed, and transported with gas or powder handling methods. The method may further comprise comminuting the friable solid, e.g., by any convenient means such as grinding, to form the powdered silylated cellulose. Alternatively, comminuting may occur during step 2) in the reactor with self-wiping blades.

The method may optionally further comprise step 4): washing the powdered silylated cellulose by combining the powdered silylated cellulose and F) a washing solvent, thereby removing residual polar aprotic swelling agent, catalyst, and/or solvent, and/or by-products that may be present. The washing solvent is not specifically restricted; however, the washing solvent may be a low boiling, polar solvent capable of dissolving residual starting materials and/or by-products without significantly solubilizing the silylated cellulose, which may be used for ease of evaporation from the silylated cellulose product. Washing in step 4) may be performed by any convenient means such as combining the washing solvent and the powdered silylated cellulose produced as described above in the reactor used in step 1) or in an agitated slurry vessel, and then draining the solvent after a sufficient time. The washing step can be repeated as many times as necessary, such as 1 to 10 times.

The method may optionally further comprise step 5): removing the washing solvent by any convenient means, such as filtering, heating, reduced pressure, and/or by purging with a gas, e.g., air or an inert gas such as nitrogen.

The resulting product is a pure silylated cellulose that was produced with low waste and high volume efficiency. The silylated cellulose produced by the method has a DS of 2.0 to 3.0, alternatively 2.2 to 3.0, alternatively 2.4 to 3.0, alternatively 2.6 to 3.0, and alternatively 2.8 to 3.0.

The starting materials used herein will be described in further detail, below.

### A) Cellulose

Starting material A), the cellulose used in the method described above, has >2.5 to 3, alternatively 3, hydroxyl groups per repeating monomeric unit in the molecule. Cellulose is a polymer of β(1→4) linked D-glucose repeating monomeric units. Cellulose may have 200 or more repeating monomeric units per molecule. Alternatively, cellulose may have at least 200, alternatively at least 300, alternatively at least 400, alternatively at least 500, alternatively at least 600, and alternatively at least 700 repeating monomeric units; while at the same time, the cellulose may have up to 10,000, alternatively up to 9,000, alternatively up to 8,000, alternatively up to 7,000, alternatively up to 6,000, alternatively up to 5,000, and alternatively up to 4,000 repeating monomeric units per molecule. Alternatively, the cellulose may have 200 to 10,000; alternatively 400 to 8,000 repeating monomeric units, per molecule.

The type of cellulose may be, for example, microcrystalline cellulose or pulp cellulose. Sources of cellulose include, but are not limited to, cotton linters, pine, and tunicin (animal derived cellulose). Cellulose is commercially available from various sources.

### B) Polar Aprotic Swelling Agent

Starting material B) used in the method described above is a polar aprotic swelling agent. Examples of suitable polar aprotic swelling agents include N-methyl pyrrolidone (NMP), N-dimethylacetamide (DMAc), dimethyl sulfoxide (DMSO), dimethyl sulfone, propylene carbonate, pyridazine, dimethylformamide (DMF), ethylene carbonate, sulfolane, tetrahydrothiophene-1-oxide, and hexamethylphosphoramide (HMPA).

Starting materials A) and B) are used in amounts such that a weight ratio of B) the polar aprotic swelling agent:A) the cellulose is <3:1, alternatively <1:1, alternatively <0.3:1 (B:A ratio). Alternatively, B:A ratio may be at least 0.1:1, alternatively 0.11:1, alternatively 0.12:1, alternatively 0.13:1, alternatively 0.14:1, alternatively 0.15:1, while at the same time the B:A ratio may be up to <0.3:1, alternatively 0.29:1, alternatively 0.28:1, alternatively 0.27:1, alternatively 0.26:1.

### C) Catalyst

Starting material C) in the method described above is a catalyst capable of catalyzing reaction of a hydroxyl group of A) the cellulose and a silicon-nitrogen (Si—N) moiety of D) the silylating agent. Examples of suitable catalysts include ammonium salts such as ammonium chloride, ammonium trifluoroacetate, or ammonium triflate; saccharin; a sulfonic acid such as methane sulfonic acid, p-toluene sulfonic acid, or trifluoromethane sulfonic acid (triflic acid); trifluoroacetic acid; trimethylsilyl chloride; or a combination thereof. Alternatively, the catalyst may be selected from the group consisting of ammonium chloride, ammonium trifluoroacetate, or Saccharin. Alternatively, the catalyst may comprise (or may be) ammonium trifluoroacetate.

The catalysts can be utilized by multiple methods those skilled in the art would understand. These could be adding C) the catalyst (such as ammonium trifluoroacetate) directly to the reactor, or dissolving C) the catalyst in B) the polar aprotic swelling agent or E) the solvent before adding the resulting catalyst solution to the reactor. Alternatively, C) the catalyst could be formed by pre-mixing certain silylating agents, such as a silazane or other silyl amines (as described below for starting material D), with an acid such as trifluoroacetic acid or triflic acid and then loading the resulting mixture containing a catalytic silyl ammonium salt to the reactor.

The amount of catalyst depends on various factors including the species of catalyst and temperature selected. However, the amount of catalyst may be at least 0.01 weight %, alternatively at least 0.1 weight %, alternatively at least 0.3 weight %, while at the same time the amount of catalyst may be up to 5 weight %, alternatively up to 4 weight %, alternatively up to 3 weight %, and alternatively up to 2 weight %; alternatively the amount of catalyst may be 0.1 weight % to 5 weight %, alternatively 0.3 weight % to 2 weight %, based on combined weights of starting materials A), B), C), and D) used in the method.

### D) Silylating Agent Having an Si—N Moiety

Starting material D) in the method described above is a silylating agent comprising a silyl amine having a silicon-nitrogen (Si—N) moiety. The Si—N moiety is reactive with the hydroxyl groups of A) the cellulose. The silylating agent may be selected from a silazane, an aminosilane, or a combination thereof. For example, the silazane can be a disilazane of formula

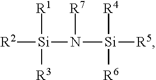

where R¹, R², R³, R⁴, R⁵, R⁶, and R⁷ are each independently selected from the group consisting of H, alkyl groups of 1 to 18 carbon atoms, and alkenyl groups of 2 to 18 carbon atoms. Suitable alkyl groups include methyl, ethyl, propyl and butyl; alternatively methyl ethyl and propyl. Suitable alkenyl groups include vinyl, allyl and hexenyl. Examples of suitable disilazane include 1,1,1,3,3,3-hexamethyldisilazane (HMDZ), 1,3-ethyl-1,1,3,3-tetramethyldisilazane; 1,3-dipropyl-1,1,3,3-tetramethyldisilazane; 1,3-dibutyl-1,1,3,3-tetramethyldisilazane; 1,3-divinyl-1,1,3,3-tetramethyldisilazane; 1,3-diallyl-1,1,3,3-tetramethyldisilazane: 1,3-dibutenyl-1,1,3,3,-tetramethyldisilazane; and 1,3-hydrido-1,1,3,3-tetramethyldisilazane.

Alternatively, the silylating agent may be an aminosilane, which may have formula: R^{N}ₓSiR⁸₄₋ₓ, where each R^{N} is an amino-functional group bonded to silicon via the nitrogen atom, and each R⁸ is independently selected from the group consisting of H, an alkyl group of 1 to 18 carbon atoms, and an alkenyl group of 2 to 18 carbon atoms, as described above for R¹, where subscript x is 1 to 3. R^{N} may have formula —NR⁹₂, where each R⁹ is independently selected from the group consisting of H, alkyl groups of 1 to 18 carbon atoms, or an aryl group of 6 to 18 carbon atoms.

Aminosilanes are exemplified by tris(dimethylamino)silane, bis(diisopropylamino)silane, (N,N-dimethylamino)trimethylsilane, trimethyl(amino)silane {H₂N—Si(CH₃)₃}, triethyl(amino)silane{H₂N—Si(CH₂—CH₃)₃}, tripropyl(amino)silane {H₂N—Si(C₃H₇)₃}, tributyl(amino)silane{H₂N—Si(C₄H₉)₃}; dimethylethyl(amino)silane; dimethylbutyl(amino)silane; trivinyl(amino)silane; dibutylethyl(amino)silane; tri(1-butenyl)(amino)silane; or triaryl(amino)silane. Suitable aminosilanes are known in the art and are commercially available from, e.g., Sigma-Aldrich, Inc. of St. Louis, Missouri, USA, or Gelest Inc. of Morrisville, Pennsylvania, USA.

Starting material D) the silylating agent is used in an amount sufficient to provide a molar ratio of Si—N moieties of D) the silylating agent:hydroxyl groups of A) the cellulose of >0.67:1 to 4:1 (D^{Si}:A^{OH} ratio). Alternatively, the D^{Si}:A^{OH} ratio may be 0.7:1 to 3.5:1, alternatively 0.8:1 to 3.0:1, alternatively 0.9:1 to 2.5:1, alternatively 1:1 to 2.0:1, alternatively 1.15:1 to 1.98:1, and alternatively 1.3:1 to 1.4:1.

### E) Solvent

Starting material E) used in the method described above is an optional solvent, which differs from B) the polar aprotic swelling agent. The solvent is not particularly restricted and may be any solvent capable of dissolving or dispersing A) the cellulose and/or C) the catalyst with one or more of the other starting materials. For example, the solvent may comprise an aliphatic hydrocarbon such as hexane, an aromatic hydrocarbon such as toluene or xylene, a halogenated hydrocarbon such as carbon tetrachloride, or an ether such as tetrahydrofuran.

The amount of solvent depends on various factors including the type and amount of catalyst selected. However, the amount of solvent may be ≥0 based on combined weights of A), B), C), and D). Alternatively, the amount of E) the solvent may be 0, or >0, while at the same time the amount of solvent may be up to 15 times the weight of catalyst, alternatively up to 12 times the weight of the catalyst. Without wishing to be bound by theory, it is thought that it is desirable to eliminate, or minimize the amount of, solvent for volume efficiency.

### F) Washing Solvent

Starting material F) in the method described above is an optional washing solvent that may be used to remove residual starting materials and/or by-products from the silylated cellulose produced by the method. Starting material F) may be different from starting materials B) and E), described above. Examples of suitable washing solvents include water, a ketone such as acetone, monohydric alcohols such as methanol or ethanol; alternatively acetone. Without wishing to be bound by theory, it is thought that a ketone such as acetone may effectively remove both polar and non-polar residuals while being easy to remove with reduced pressure from the silylated cellulose.

### Methods of Use

The silylated cellulose prepared as described herein may be used in various end use applications. For example, the silylated cellulose may be used instead of the cellulose derivative described in U.S. Pat. No. 10,851,180 in optical films for image display devices. Alternatively, the silylated cellulose prepared as described above may be used as a thickening polymer in a personal care application (such as a cosmetic formulation or a sun care formulation), e.g., in addition to or instead of the silylated cellulose polymer disclosed in PCT Patent Publication WO/2022/066591.

### EXAMPLES

These examples are provided to illustrate the invention to one skilled in the art and are not to be construed to limit the scope of the invention set forth in the claims. Starting materials used in the examples are summarized below in Table 1.

TABLE 1
Starting Materials

| Starting Material | Description | Source |
|---|---|---|
| A1 | Microcrystalline cellulose | Avicel PH-101 from IFF |
| A2 | Pulped cellulose | Ground E60 From |
| | | Georgia Pacific |
| B1 DMSO | Dimethyl sulfoxide | Sigma-Aldrich |
| C1 NH4Cl | Ammonium chloride | Sigma-Aldrich |
| D1 HMDZ | Hexamethyldisilazane | Dow |
| F1 | Acetone | Oakwood Chemicals |

Reactions with Stripping

In this Example 1, cellulose was silylated in a Sigma Blade style mixer (reactor) by loading 243 grams microcrystalline cellulose, then loading a pre-dissolved solution of 68.25 grams DMSO and 6.07 grams NH4Cl and mixing for 10 minutes. 483.25 grams of HMDZ were loaded to the reactor and the hot oil supply to heat the reactor was set to 90° C. When the reaction mixture temperature stabilized, the reactor was held at temperature for 1 hour. At reaction completion, the resulting reaction product was a paste that had a thick taffy-like appearance. After holding at temperature, vacuum was pulled to <200 torr and held for an hour ensuring no more liquid was dripping in the vacuum flask. As vacuum was being held, the reaction product converted from a paste to a flaky friable powder. 547.2 grams of resulting crude product was recovered. The resulting silylated cellulose had a DS of 3.0.

In this Example 2, cellulose was silylated in a Sigma Blade style mixer (reactor) by loading 304 grams pulped cellulose, then loading a pre-dissolved solution of 86.4 grams DMSO and 6.07 grams NH4Cl, and mixing for 25 minutes. 604.1 grams of HMDZ were loaded to the reactor, and the hot oil supply to the reactor was set to 90° C. When the reaction mixture temperature stabilized, the reactor was held at temperature for 1 hour. At reaction completion, the material was a paste that had a thick taffy-like appearance. After holding at temperature, vacuum was pulled to <200 torr and held for an hour ensuring no more liquid dripping in the vacuum flask. As vacuum was being held, the reaction product converted from a paste to a flaky friable powder. 678.35 grams of crude product was recovered. The resulting silylated cellulose had a DS of 2.4.

Reaction with Stripping and then Washing and Filtering with a Pressure Filter

In this Example 3, cellulose was silylated in a Sigma Blade style mixer by loading 242 grams pulped cellulose, then loading a pre-dissolved solution of 68.4 grams DMSO and 6.0 grams NH4Cl and mixing for 10 minutes. 484 grams of HMDZ were loaded to the reactor and then heated to 73° C. and held for one hour. At reaction completion, the reaction product was a paste that had a thick taffy-like appearance. After holding at ˜73° C., vacuum was pulled to <200 mmHg and held for an hour after dripping stopped. As vacuum was being held, the reaction product converted from a paste to a flaky friable powder. 540.9 grams of resulting crude product were recovered.

The crude product was loaded to a pressure filter and filled with acetone until the level was just above the solids. The resulting material was hand mixed and held for ˜15 minutes and then drained. Additional acetone was loaded to get the level just above the solids and hand mixed and held for ˜15 minutes and drained. A final acetone wash was loaded until the acetone level was just above the solids and hand mixed and held for ˜15 minutes and then drained. The pressure filter was then sealed and a light N₂ purge was placed on the filter and left overnight. In the morning, the resulting silylated cellulose was removed. The silylated cellulose contained a full silicon DS of 3.0.

Reaction with Stripping and then Washing and Filtering with a Büchner Funnel

In this Example 4, cellulose was silylated in a Sigma Blade style mixer by loading 234.7 grams pulped cellulose, then loading a pre-dissolved solution of 68.2 grams DMSO and 6.0 grams NH4Cl and mixing for 10 minutes. 484 grams of HMDZ were loaded to the reactor and then the reaction mixture was heated to 73° C. and held for one hour. At reaction completion, the resulting reaction product was a paste that had a thick taffy-like appearance. After holding at ˜73° C., vacuum was pulled to <200 mmHg and held for an hour after dripping stopped. As vacuum was being held, the reaction product converted from a paste to a flaky friable powder. 571.52 grams of resulting crude product was recovered.

Of the crude product, 22.77 grams were loaded to a Büchner funnel in a hood. 79 grams of acetone were loaded to the funnel with the crude product and hand mixed for one minute. The acetone was then drained by pulling vacuum on the drain flask while mixing the crude product and acetone by hand. Another 109 grams of acetone were loaded and mixed/drained similarly. Another 100 grams of acetone were then added, mixed and drained similarly. The residual sample was spread thin on a plate in the hood overnight to evaporate residual acetone. In the morning 19.37 grams of dry powdery silylated cellulose was recovered. The silylated cellulose contained a full silicon DS of 3.0.

### Comparative Example—Non Self-Wiping Blades (Single Agitator Shaft)

In this Example 5, cellulose was silylated in a horizontal plow style mixer by loading 2.64 kg pulped cellulose, then loading a pre-dissolved solution of 740 g DMSO and 65.4 g NH4Cl and mixed for 30 minutes. The mixer was heated to 90° C. When the internal temperature reached 68° C., 5.25 kg of HMDZ was loaded over 10 minutes. The reactor was held at temperature of 90° C. for 1.5 hours; however, high amps were observed. When vacuum was pulled on the system, the agitators faulted and were unable to be started back up. Upon opening the mixer it was observed that the entire mixer volume was filled with a hardened foam-like material that needed to be manually cut out of the mixer.

### INDUSTRIAL APPLICABILITY

Without wishing to be bound by theory, it is thought that the method described herein can provide silylated cellulose with a DS>2, alternatively DS>2.3, and alternatively DS≥2.4 to 3.0. Examples 1 to 4 demonstrated that a silylated cellulose with a degree of substitution≥2.8 was prepared by the method of this invention in a reactor with self-wiping blades. Examples 1 to 4 and 5 showed that the method of this invention that employed a stripping step after the reaction provided a benefit of providing the silylated cellulose in the form of a powder that is easy to transport in a method with good volume efficiency that did not require a solvent to be used during the silylation reaction. Furthermore, the method of this invention is suitable for commercial scale production of silylated celluloses, such as silylated cellulose. The examples above demonstrated that the method can produce a batch of silylated cellulose≥500 g, alternatively ≥600 g, alternatively ≥1 kg, and alternatively ≥3 kg.

Without wishing to be bound by theory, it is thought that the method of this invention may provide a further benefit of minimizing or eliminating yellowing of the silylated cellulose produced by performing the silylation reaction in step 2) at a temperature≤85° C.

### Definitions and Usage of Terms

All amounts, ratios, and percentages herein are by weight, unless otherwise indicated. The articles, ‘a’, ‘an’ and ‘the’ each refer to one or more unless otherwise indicated. The singular includes the plural unless otherwise indicated. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III.

DS, or Degree of Substitution, is defined as the average number of hydroxyl groups per monomeric unit of cellulose that is silylated. DS is determined by ATR-FTIR, as follows. The degree of substitution, DS, of —SiR₃ in the silylated cellulose prepared by the method described herein was determined using techniques known in the art based on Attenuated Total Reflection—Fourier Transform Infrared Spectroscopy analyzing spectra peak areas calculated with MATLAB using the spectral parameters provided in TABLE 2 with the DS values determined as reported in TABLE 3.

TABLE 2

| | |
|---|---|
| Integration (cm⁻¹) | Baseline (cm⁻¹) |

| Species | Start | End | Start | End |
|---|---|---|---|---|
| —Si(CH₃)₃ | 1277 | 1220 | 1278 | 1219 |
| —OH | 3685 | 3033 | 3697 | 3040 |

TABLE 3
DS Values for Examples above.

| Sample | SiMe | CO | OH | [OH]/[Si] | DS | Si wt % | OH wt % |
|---|---|---|---|---|---|---|---|
| Ex. 1 (13) | 3.9 | 27.3 | −0.3 | 0.00 | 3.0 | 22.2% | 0.0% |
| Ex. 2 (7) | 4.8 | 35.4 | 1.6 | 0.16 | 2.4 | 20.0% | 3.2% |
| Ex. 3 (17) | 0.9 | 7.3 | −0.4 | 0.00 | 3.0 | 22.2% | 0.0% |
| Ex. 4 (15) | 4.9 | 35.3 | −0.6 | 0.00 | 3.0 | 22.2% | 0.0% |

The abbreviations used herein have the definitions in Table 4.

TABLE 4
Abbreviations

| Abbreviation | Definition |
|---|---|
| ATR-FTIR | Attenuated Total Reflection - Fourier Transform Infra-Red |
| ° C. | Degree Celsius |
| DS | Degree of substitution |
| g | gram |
| h | hour |
| Kg or kg | kilogram |
| min | minute |
| RT | Room temperature of 23° C. ± 3° C. |

1. A method for preparing a silylated cellulose, wherein the method comprises:
1) combining starting materials comprising
A) a cellulose comprising repeating monomeric units and having >2.5 to 3 hydroxyl groups per monomeric unit,
B) a polar aprotic swelling agent,
C) a catalyst, and
D) a silylating agent comprising a silyl amine having a silicon-nitrogen moiety,
thereby forming a reaction mixture; and
2) mixing the reaction mixture in a reactor with self-wiping mixing blades, and heating the reaction mixture at a temperature of 30° C. to 150° C., thereby forming a reaction product comprising the silylated cellulose with a degree of substitution>2, and where the starting materials are used in amounts such that the reaction mixture or the reaction product is a paste.

2. The method of claim 1, further comprising drying A) the cellulose before step 1).

3. The method of claim 1, further comprising: before step 1), dissolving C) the catalyst in B) the polar aprotic swelling agent, E) a solvent, or a combination thereof.

4. The method of any one of claims 1 to 3, where B) the polar aprotic swelling agent and A) the cellulose are used in amounts such that a weight ratio of B) the polar aprotic swelling agent:A) the cellulose is 0.1:1 to <3:1 (B:A ratio).

5. The method of claim 1, where D) the silylating agent and A) the cellulose are used in amounts such that a molar ratio of silicon-nitrogen moieties to hydroxyl groups is >0.5:1 to 4:1 (D^{Si}:A^{OH} ratio).

6. The method of claim 1, where the catalyst comprises ammonium chloride or ammonium trifluoroacetate.

7. The method of claim 1, where the method further comprises: forming C) the catalyst by a method comprising reacting a silazane with an acid ex-situ.

8. The method of claim 1, where step 2) is performed at a pressure of 730 mmHg (97 kPa) to 790 mmHg (105 kPa).

9. The method of claim 1, where step 2) is performed at a temperature of 50° C. to 85° C.

10. The method of claim 1, where the method further comprises step 3): heating the reaction product at a temperature of >50° C. to 90° C. at a pressure of >0 kPa to <101 kPa, and comminuting the reaction product, thereby forming a powdered silylated cellulose.

11. The method of claim 10, further comprising step 4): washing the powdered silylated cellulose from 1 to 10 times by combining the powdered silylated cellulose and F) a washing solvent.

12. The method of claim 11, wherein E) the washing solvent is removed with heating, reduced pressure, and/or by purging with a gas.

13. The method of claim 1, where the reactor is a kneader reactor or a sigma blade mixer.

14. The method of claim 1, where the silylated cellulose is produced in an amount of at least 500 grams.
